(19) United States
(12) Patent Application Publication
(10) Pub. No.: US 2017/0174148 A1
(43) Pub. Date: Jun. 22, 2017

(54) CURVED LINER FOR A FLOOR OR TRUCK DUMP BODY

(71) Applicant: Caterpillar Inc., Peoria, IL (US)

(72) Inventor: Steven J. Fujan, Lincoln, NE (US)

(73) Assignee: Caterpillar Inc., Peoria, IL (US)

(21) Appl. No.: 14/970,650

(22) Filed: Dec. 16, 2015

(51) Int. Cl. B60R 13/01; B62D 65/16

(52) U.S. Cl. CPC B60R 13/01; B62D 65/16

(57) ABSTRACT

A liner for a floor of a truck dump body includes a frame formed of a plurality of frame bars coupled to the dump body floor; and a plurality of grid bars coupled to and extending substantially perpendicular to a frame bar to create a plurality of open bins configured to receive payload material; wherein the plurality of frame bars are curved to match a curvature of the dump body floor. A method of applying a curved liner to a truck dump body includes burning to shape a plurality of frame bars; attaching a plurality of grid bars substantially perpendicular to the plurality of frame bars to create a plurality of open bins; and welding the frame bars to a truck dump body floor; wherein the truck dump body floor has a curvature; and wherein the plurality of frame bars are curved to match the curvature of the truck dump body floor.

### TECHNICAL FIELD

The present disclosure relates generally to large dump truck, and more particularly to curved liners that protect the floor of a truck dump body.

### BACKGROUND

Dump trucks are known for lading, transporting, and dumping payloads. The dump body in a truck is subjected to substantial frictional wear cause by payload material loading and dumping operations. For example, in typical loading and dumping operations, such as those in heavy-duty mining, components of mined ore usually have a hardness that is greater than the hardness of the truck's dump body. Consequently, these mined ore components wear away the surface of the dump body when moving in the truck during loading and dumping operations. The wear is especially strong in the rearward portion of the dump body where the material flows past during dumping operations.

One way to mitigate the wear on a dump body is to construct the dump body with materials that are harder than the mined ore. However, these materials can be expensive. Alternatively, dump bodies can have wear plates or liners. One example of a liner for a dump truck body is known from U.S. Pat. No. 6,129,409 to D'Amico. D'Amico '409 includes a rock box liner with a grid pattern coupled to the flat floor of the truck's dump body. However, flat liners cannot be used on curved dump bodies.

### SUMMARY OF THE INVENTION

The disclosure relates to a curved liner for a floor of a truck dump body including a frame formed of a plurality of frame bars coupled to the dump body floor; and a plurality of grid bars coupled to and extending substantially perpendicular to the frame bars to create a plurality of open bins, at least one of the open bins comprising a ramp to allow movement of a payload material into the open bin; wherein the frame is curved to match a curvature of the dump body floor.

In one embodiment, a method of applying a curved liner to a truck dump body includes burning to shape a plurality of frame bars; attaching a plurality of grid bars substantially perpendicular to the plurality of frame bars to create a plurality of open bins; and welding the frame bars to a truck dump body floor; wherein the truck dump body floor has a curvature; wherein the plurality of frame bars are curved to match the curvature of the truck dump body floor.

In another embodiment, a method of applying a curved liner to a floor of a truck dump body includes burning to shape a plurality of grid bars; attaching a plurality of frame bars substantially perpendicular to the plurality of grid bars to create a plurality of open bins; welding the grid bars to a truck dump body floor, wherein the truck dump body floor has a curvature; and wherein the plurality of grid bars are curved to match the curvature of the truck dump body floor.

### BRIEF DESCRIPTION OF THE DRAWINGS

FIG. 1 is a perspective view of a dump body with a curved floor and a curved liner; and

FIG. 2 is a sectional view of the liner.

### DETAILED DESCRIPTION

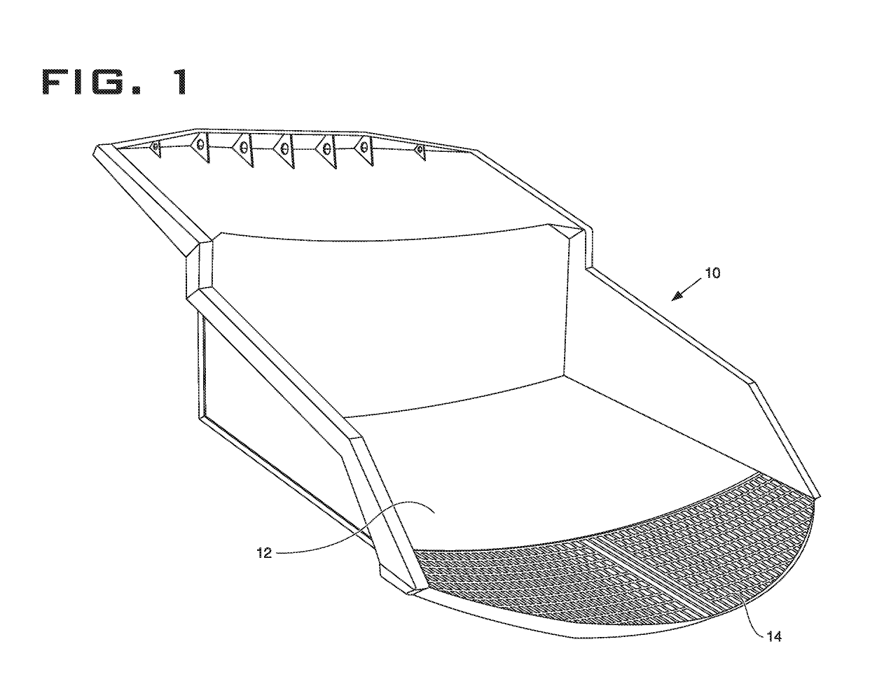

Referring to FIG. 1, there is shown a view of a dump body 10 of a truck according to an embodiment of the present disclosure. The truck can be any sort of hauling machine with a dump body 10 that is capable of loading and unloading a payload. For example, the truck can be a mining truck, an off-highway truck, or an on-highway truck. The dump body 10 includes a floor 12 and a liner 14. As shown in FIG. 1, the dump body 10 is curved. In some embodiments, the curvature of the dump body 10 is greater than 5 degrees. In one embodiment, the curvature of the dump body is greater than 10 degrees.

A liner 14 having a grid-like pattern is coupled to the floor 12 and covers a portion of the floor 12. Specifically, the liner 14 is coupled to the rear portion of the floor 12. For example, the liner 14 can be welded to the floor 12.

The liner 14 can be formed of one or more frames. The liner 14 can be replaced if it is damaged or is worn. The liner can be replaced wholly or in parts, as needed.

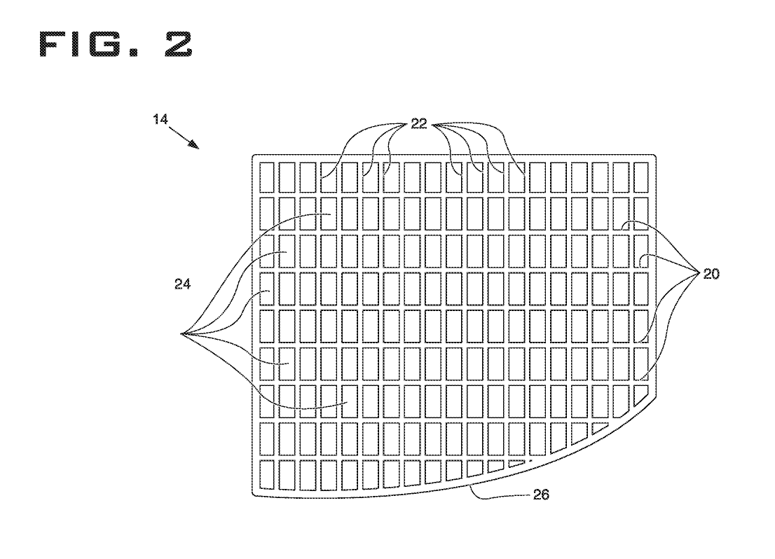

Referring to FIG. 2, the liner 14 can be formed of two or more frame bars 20. In one embodiment, the frame bars 20 can be welded to the floor. The frame bars 20 can be curved to match the curvature of the floor 12. Substantially perpendicular to the frame bars 20 are two or more grid bars 22. These grid bars 22 are coupled to the frame bars 20 and create a plurality of open bins 24. The open bins 24 receive material when it is loaded into the dump body 10.

For example, when a dump body 10 is being loaded with material, some of the material will be deposited into the open bins 24. In addition, material may be deposited into the open bins 24 during a dumping operation. The material in the open bins 24 will receive some of the wear that would be subjected to the floor 12 of the dump body 10, thereby increasing the life of the floor 12 of the dump body 10.

The frame bars 20 can be formed through many processes for forming strong and wear resistant metal, such as burning to shape, casting, extruding, or drawing. The grid bars 22 can be formed through many processes for forming strong and wear resistant metal, such as burning to shape, casting, extruding, or drawing. In one embodiment, the frame bars 20 can be burned to shape to form the needed curvature to match the curvature of the floor 12 of the dump body 10. In another embodiment, the grid bars 22 can be burned to shape to form the needed curvature to match the curvature of the floor 12 of the dump body 10. The frame bars 20 can be welded to the floor 12 to provide a base for the grid bars. Alternatively, the frame bars 20 and grid bars 22 can be welded to floor 12. In another embodiment, the frame bars 20 may be removed and replaced, if they are damaged, without removing the grid bars 22 from the floor 12.

The grid bars 22 can be formed of similar processes and can be linear or curved, depending on the contour of the floor 12. The grid bars 22 can be coupled to the frame bars 20 by welding, bolting on, or with epoxy. It may be possible to remove and replace some grid bars 22, if they are damaged or worn, without removing the frame bars 20 from the floor 12. The grid bars 22 can be curved to match the curvature of the floor 12 of the dump body 10.

### INDUSTRIAL APPLICABILITY

In an embodiment, a method of applying a curved liner to a truck dump body is disclosed. The method includes burning to shape a plurality of frame bars 20, attaching a plurality of grid bars 22 substantially perpendicular to the plurality of frame bars 20 to create a plurality of open bins 24, and welding the frame bars 20 to a truck dump body. The method also discloses that the dump body 10 has a curvature and the plurality of frame bars 20 are curved to match the curvature of the dump body 10. In another embodiment, the grid bars 22 can be curved to match the curvature of the floor 12 of the dump body 10.

The present description is for illustrative purposes only, and should not be construed to narrow the breadth of the present disclosure in any fashion. Thus, those skilled in the art will appreciate that various modifications might be made to the presently disclosed embodiments without departing from the intended spirit and scope of the present disclosure.

What is claimed is:

1. A liner for a floor of a truck dump body comprising:
a frame formed of a plurality of frame bars coupled to a floor of a dump body; and
a plurality of grid bars coupled to and extending substantially perpendicular to a frame bar to create a plurality of open bins configured to receive payload material;
wherein the plurality of frame bars are curved to match a curvature of the floor of the dump body.

2. The liner of claim 1, wherein the curvature of the floor of the dump body greater than 5 degrees.

3. The liner of claim 1, wherein the curvature of the floor of the dump body is greater than 10 degrees.

4. The liner of claim 1, wherein the plurality of grid bars are curved to match the curvature of the floor of the dump body.

5. A method of applying a curved liner to a floor of a dump body comprising, the method comprising:
burning to shape a plurality of frame bars;
attaching a plurality of grid bars substantially perpendicular to the plurality of frame bars to create a plurality of open bins; and
welding the frame bars to a floor of a dump body; wherein the floor of the dump body has a curvature;
wherein the plurality of frame bars are curved to match the curvature of the floor of the dump body.

6. The method of claim 5, wherein the curvature of the floor of the dump body is greater than 5 degrees.

7. The method of claim 5, wherein the curvature of the floor of the dump body is greater than 10 degrees.

8. The method of claim 5, wherein the plurality of grid bars are curved to match the curvature of the floor of the dump body.

9. A method of applying a curved liner to a floor of a dump body, the method comprising:
burning to shape a plurality of grid bars;
attaching a plurality of frame bars substantially perpendicular to the plurality of grid bars to create a plurality of open bins;
welding the grid bars to a floor of a dump body, wherein the floor of the dump body has a curvature; and
wherein the plurality of grid bars are curved to match the curvature of the floor of the dump body.

10. The method of claim 9, wherein the curvature of the floor of the dump body is greater than 5 degrees.

11. The method of claim 9, wherein the curvature of the floor of the dump body is greater than 10 degrees.

12. The method of claim 9, wherein the plurality of frame bars are curved to match the curvature of the floor of the dump body.
